(19) United States
(12) Patent Application Publication
(10) Pub. No.: US 2008/0095692 A1
(43) Pub. Date: Apr. 24, 2008

(54) Method For Producing Fabricated Parts Based On Beta-Sic For Using In Aggressive Media

(76) Inventor: Charlotte Pham, Saverne (FR)

Correspondence Address: Womble Carlyle Sandridge & Rice, PLLC;Attn: Patent Docketing 32nd Floor, P.O. Box 7037, Atlanta, GA, 30357-0037, US

(21) Appl. No.: 11/569,103

(22) PCT Filed: May 10, 2005
(86) PCT No.: PCT/FR05/01163

§ 371 Date: Nov. 14, 2006

(30) Foreign Application Priority Data
May 14, 2004 (FR) 0405284

(51) Int. Cl. C01B 31/36; B29C 35/02

(52) U.S. Cl. 423/345; 264/80

(57) ABSTRACT

The invention relates to a method for producing a composite material based on β-SiC, said method comprising the following steps: (a) a precursor mixture is prepared, said mixture comprising at least one β-SiC precursor with at least one, preferably thermosetting, carbonated resin, (b) the precursor mixture is fabricated, especially in the form of granulated material, plates, tubes or bricks, in order to form an intermediate part; (c) the resin is polymerised; (d) said intermediate parts are introduced into a receptacle; (e) said receptacle is closed by a closing means in such a way that an over-pressure can escape; and (f) the intermediate parts are thermally treated at a temperature of between 1100 and 1500° C. in order to eliminate the organic constituents of the resin and to form β-SiC in the final part.

### TECHNICAL FIELD OF THE INVENTION

The present invention relates to ceramics based on β-SiC for use in aggressive media, such as occur particularly in chemical and electrometallurgical engineering, and more particularly refractory parts or bricks used in incinerators or electrolysis cells. It relates more particularly to a simplified method for producing such parts or bricks.

### PRIOR ART

The preparation of prefabricated silicon carbide parts by vacuum heating at moderate temperature of a mixture of silicon and/or silica and a carbon containing compound is described in patent EP 0 313 480 (Pechiney). An improvement to this method, for the purpose of decreasing its cost, is given in patent EP 0 543 752 (Pechiney), which consists in replacing the vacuum heating by a heating with neutral gas blanket (inert gas or nitrogen).

Document EP 0 356 800 (Shin-Etsu Chemical Co) describes a binder composition for silicon carbide, comprising fine powders of silicon carbide, silicon and carbon and carbon-containing resins. This composition is compressed between two SiC parts and the whole is heated to 1500° C. to cause the binder components to react and obtain a solid interface between the two parts. The heat treatment is carried out preferably under inert gas or under vacuum. One example implemented by heating the parts in air shows that the mechanical strength of the interface is inferior to that obtained when the treatment is carried out under argon.

### Problem Posed

To form β-SiC at a temperature of about 1100-1500° C., the prior art methods require heat treatment under an inert gas atmosphere, typically nitrogen or argon, or under vacuum, because the chemical resistance of the parts obtained in air is unsatisfactory. This incurs an additional investment and operating cost, associated with the management of the vacuum or inert gases, the consumption of the inert gases, and the maintenance of the vacuum pumps. It would be desirable to have a method for producing these parts in air and at standard pressure, without necessarily sacrificing the functional performance of the parts obtained.

### DETAILED DESCRIPTION OF THE INVENTION

The problem is solved according to the present invention by confining the intermediate parts to be treated in a box, typically ceramic, for isolating them from the furnace atmosphere.

The inventive method comprises:
(a) the preparation of a blend called a “precursor blend” comprising at least one β-SiC precursor with at least one carbon-containing resin, preferably thermosetting,
(b) the forming of said precursor mixture, particularly into granules, plates, tubes or bricks, for forming an intermediate part;
(c) the curing of the resin;
(d) the introduction of said intermediate parts into a receptacle;
(e) the closure of said receptacle by a closure means allowing a gas overpressure to escape;
(f) the heat treatment of said intermediate parts at a temperature of between 1100 and 1500° C. to remove the organic components of the resin and form β-SiC in the final part.

The term “β-SiC precursor” means here a compound which forms β-SiC under the heat treatment conditions (step (e)) with the components of the resin. As a β-SiC precursor, silicon is preferred, and more particularly in powder form. This silicon powder may be a commercial powder, having a known particle size distribution and purity. For reasons of uniformity, the particle size distribution of the silicon powder is preferably between 0.1 and 20 μm, preferably between 2 and 20 μm and more especially between 5 and 20 μm. Said precursors may also be used in the form of particles or fibers.

The term “carbon-containing resin” means here any resin containing carbon atoms. It is neither necessary nor useful for it to contain silicon atoms. It is advantageous for the silicon to be added exclusively by the β-SiC precursor. The resin is advantageously selected from thermosetting resins containing carbon, and particularly from phenolic, acrylic, or furfurylic resins. A resin of the phenolic type is preferred.

In the precursor blend, the respective quantities of resin and β-SiC precursor are adjusted in order to convert the β-SiC precursor quantitatively to β-SiC. For this purpose, the quantity of carbon contained in the resin is calculated. Part of the carbon may also be provided by the direct addition of a carbon powder to the mixture of carbon-containing resin and β-SiC precursor. This carbon powder may be a commercial powder, for example carbon black, having a known particle size distribution and purity. For reasons of uniformity of the mixture, a particle size distribution smaller than 50 μm is preferred. The choice of the composition of the blend results from a compromise between the viscosity, the cost of the raw materials and the desired final porosity. To obtain complete conversion of the β-SiC precursor to β-SiC and thereby obtain a final material free of Si not bound in the SiC structure, a slight excess of carbon is preferred in the precursor blend. This excess carbon can then be burned in air. However, the excess carbon must not be excessive to avoid generating an excessive porosity in the material after combustion of the residual carbon, thereby weakening the mechanical strength of the final part.

The precursor blend can be formed by any known method, such as molding, extrusion, rolling or pressing between at least two surfaces, to obtain three-dimensional forms such as granules, tubes, bricks, plates or tiles. The method selected is adapted to the viscosity of the precursor blend, which itself depends on the viscosity of the resin and the composition of the precursor blend. By way of example, it is possible to obtain plates 1 mm thick and having a length and width of one to several decimeters. Bricks of between a few centimeters to a few decimeters or more in size can also be produced. Also obtainable are parts having more complex shapes, particularly by molding. Pressing is preferred for producing bricks.

Said precursor blend is then heated in air to a temperature of between 100° C. and 300° C., preferably between 150° C. and 300° C., more preferably between 150° C. and 250° C., and even more preferably between 150° C. and 210° C. The duration of this treatment, during which the resin is cured and the part is hardened, is typically between 0.5 hour and 10 hours at the temperature plateau, preferably between 1 h and 5 h, and even more preferably between 2 and 3 hours. During this step, the material liberates volatile organic compounds which create a residual porosity that varies according to the carbon content in the composition of the precursor blend and the conditions applied during the curing. It may be preferable to minimize this porosity, particularly for producing thick plates (typical thickness at least 2 mm) and bricks. An intermediate part is thereby obtained, having a certain mechanical strength and which can therefore be handled easily.

Said intermediate part thereby obtained is introduced into a receptacle, as explained below, and heated to a temperature of between 1100° C. and 1500° C. for a period ranging from 1 to 10 hours, preferably between 1 and 5 hours and more especially between 1 and 3 hours. The optimal temperature range is preferably between 1200° C. and 1500° C., more especially between 1250° C. and 1450° C. The most preferred range is between 1250° C. and 1400° C. The SiC formed from the carbon in the resin and from the β-SiC precursor is β-SiC. During this carbonizing step, the temperature of the parts rises progressively, causing the decomposition of the carbon-containing resin. This decomposition is accompanied by the generation of volatile organic compounds which effectively expel the air initially present between the parts, and in any porosity thereof. With most resins, particularly thermosetting resins, the gas release accompanying the decomposition of the carbon-containing resin is complete at about 800° C. The silicon carbide formation reactions only become effective above 1100° C., and essentially take place in the absence of molecular oxygen.

This synthesis method may lead to the presence in the final parts of a carbonaceous residue which is easily removed by heating in the open air at 700° C. for 3 hours.

The essential step of the present invention is the introduction of the intermediate parts into a receptacle, which is then closed by a closure means allowing a gas overpressure to escape.

The receptacle is preferably of an inert ceramic, for example refractory bricks. In an advantageous implementation of the invention, said receptacle is filled fairly compactly, minimizing the unoccupied volume. If the feed is insufficient, it can be supplemented by filling the volume of the receptacle that is unoccupied by said intermediate parts to be treated with an inert solid, preferably easily separable and recoverable. It may, for example, consist of β-SiC or α-SiC bricks, or α-SiC particles. In a preferred embodiment of the inventive method, the volume occupied by the gas in the receptacle is not more than 50% greater than the external volume of the intermediate parts, preferably not more than 20% and even more preferably not more than 10%. The term “external volume” means here the volume calculated from the outer dimensions of the intermediate parts to be treated, without taking account of their internal surface associated with the porosity.

It is also preferable for the gas release generated by the intermediate parts between ambient temperature and 800° C. to be at least equal to twice, preferably at least five times, and even more preferably at least 10 times, the volume occupied by the gas in the receptacle. The term “volume occupied by the gas in the receptacle” means here the difference between the internal volume of the receptacle and the sum of the external volume of the intermediate parts to be treated and the volume of any inert solids added.

The receptacle must then be closed by an appropriate closure means, for example by a ceramic lid or plug. The applicant has discovered that it is not only useless for this closure to be sealed, but even harmful. In fact, it is necessary for the closure means to allow the escape of the gas overpressure (carbon monoxide, volatile organic compounds, etc.) formed during the curing. In most cases, and particularly when the edges of the receptacle and the lid are fairly plane and smooth, it is sufficient to simply place the lid in a visually tight manner upon the opening of the receptacle. A sealed closure means equipped with a valve can also be provided. Thus, the gas overpressure can escape, and at the same time, the ambient air does not appreciably obtain access to the products, or in any case during the curing at high temperature. During the cooling, the pressure in the receptacle drops; the applicant has found that it is then no longer harmful for the air to reach the products, because the temperature is sufficiently low so that the ambient air no longer reacts appreciably with the products.

It is feasible to introduce the intermediate parts directly into the furnace while taking care to fill the furnace space completely, by adding inert parts in sufficient quantities to occupy the volume as required, and to close the furnace with a closure means allowing the gas overpressure to escape. In this embodiment, it is the furnace itself which acts as a receptacle. However, this embodiment has drawbacks: the fact that the furnace is completely filled is liable to disturb the airflow and unacceptably disturb the thermal equilibrium inside the furnace. Moreover, this embodiment is impractical in the case of open furnaces, or large furnaces. The use of a receptacle confers on the method both effective protection against the ambient air, and great simplicity and flexibility of use.

The inventive method is suitable for producing β-SiC-based refractory bricks or plates without binder, with a density higher than 1.5 g/cm³ and a thickness of at least 1 mm, preferably at least 3 mm, and even more preferably at least 5 mm. The smallest cross section of said plates is advantageously at least 15 mm², and preferably at least 50 mm², with a ratio of length or width to thickness of at least 10 and preferably at least 15. In another advantageous embodiment, bricks are produced. The smallest dimension of said bricks is advantageously at least 10 mm, and preferably at least 50 mm or even 100 mm. The smallest cross section of said bricks is advantageously at least 20 cm², preferably at least 75 cm² and even more advantageously at least 150 cm², with a ratio of length or width to thickness of at least 3.

In both cases, the excess carbon should be limited and the curing should be slow to avoid the formation of large bubbles liable to weaken the material during its carbonizing.

The density of the material can reach 2.8 g/cm³. For use in an incinerator or an electrolysis cell, a density of at least 2.4 g/cm³ is preferred. The most preferred density for this use is between 2.45 and 2.75 g/cm³.

In a particular embodiment of the present invention, inclusions whereof at least part consists of α-SiC are added to the precursor blend. In this case, step (a) indicated above is replaced by step (aa):
(aa) the preparation of a precursor blend comprising inclusions, whereof at least part consists of α-SiC, and a β-SiC precursor, which may be in the form of powder, particles, fibers or inclusions of various sizes, with a carbon-containing resin, preferably a thermosetting resin.

Typically, α-SiC having a variable particle size distribution ranging from 0.01 to a few millimeters can be used as inclusions. By way of example, a particle size of between a few tens of μm and 3 mm is suitable. This silicon carbide may consist of any silicon carbides known today. Part of the α-SiC may be replaced by alumina, silica, TiN, Si₃N₄ or other inorganic solids which do not decompose and do not sublime at the synthesis temperature of the final composite. By way of example, the weight fraction of said inclusions may reach 80 and even 95% of the total weight of the precursor blend. If the products are intended for use as lining for molten salt electrolysis cells (for example for the production of aluminum from a molten mixture of alumina and cryolite), it is preferable for at least 50% by weight of the inclusions, and preferably at least 70%, to consist of α-SiC. The same applies to products intended for lining incinerators.

The solid of the inclusions is not limited to a precise macroscopic form but may be used in various forms such as powder, particles, fibers. By way of example, to improve the mechanical properties of the final composite, α-SiC-based fiber inclusions are preferred. These fibers may have a length exceeding 100 μm.

These inclusions, at least part of which must comprise α-SiC, are blended with a carbon-containing resin, preferably thermosetting, containing a given quantity of β-SiC precursor, preferably in powder form and having a particle size distribution ranging from 0.1 to several microns.

A composite material of the α-SiC/β-SiC type is thereby obtained, comprising α-SiC particles in a β-SiC matrix, which does not need to contain other binders or additives.

In another particular embodiment of the present invention, the supplementary infiltration treatment can be carried out following the same procedure described: dipping of said material in a mold containing the resin, curing and finally, carbonizing treatment. Said resin must contain a sufficient quantity of β-SiC precursor, for example in silicon powder form. This supplementary treatment is useful for improving the mechanical strength and/or eliminating the problems inherent in the presence of an undesirable porosity which leads to better resistance to attack by corrosive media, particularly fluorinated media, concentrated acids and alkaline media.

Without the addition of inclusions, a pure and porous β-SiC is obtained, which can be used as catalyst support or as catalyst.

In a preferred alternative of the method of the present invention, the carbon and silicon are intimately mixed as follows: the silicon powder (average particle size about 10 μm), is blended with a phenolic resin, which, after curing, supplies the carbon source necessary for the formation of β-SiC. The inclusions are then blended with the resin and the whole is poured into a mold having the shape of the final component desired. After curing, the solid formed is transferred to a receptacle placed in a furnace for the final carbonizing of the matrix. If the receptacle is not full, inert material can be added, for example, refractory bricks of the same type already fired. The receptacle is closed by a closure means such as a ceramic lid or plug.

During the temperature rise, the cured resin decomposes and liberates volatile organic compounds which create an overpressure in the receptacle. This overpressure must be able to escape, either via a specific valve arranged in the receptacle or the lid, or simply because the connection between the receptacle and the lid is not gastight.

The fact that all the components are intimately mixed considerably increases the final SiC yield with very little silicon loss in the gas phase.

The method according to the present invention is suitable for producing materials or composites with a β-SiC-based matrix which can contain inclusions based on silicon carbide or other materials withstanding use in aggressive, strongly acidic or basic media, and under high thermal stresses.

Numerous advantages are derived from the present invention compared with prior art methods, particularly comprising the following:

(i) the inventive material can be produced at a significantly lower cost compared with known methods. This is due to three factors: first, the low costs and limited number of raw materials (resin constituting the carbon source, silicon powder). Second, a non-negligible energy saving because the inventive method can be implemented at relatively low temperatures, i.e. ≦1400° C., compared with those used in the prior art. And above all, third, the inventive method avoids the extra investment and operating costs associated with the management of vacuum and inert gases, the consumption of inert gases and the maintenance of the vacuum pumps;

(ii) the blend can be formed preferably before curing by extrusion, pressing or molding. This is easy because of the type of starting material, that is, a viscous matrix based on resin and silicon powder, which can contain dispersed α-SiC powder. This serves to preform the material into relatively complex shapes which are not always easy to obtain with known methods. Alternatively, the part can be formed by machining after curing the resin, preferably before the heat treatment (step (d));

(iii) the strong chemical and physical affinity between the various components of the composite allows better wetting of the α-SiC particles or inclusions by the β-SiC-based matrix. This is due to their similar chemical and physical properties despite their different crystallographic structure, i.e. α-SiC (hexagonal) and β-SiC (cubic). These similarities essentially derive from the specificity of the Si—C chemical bond which governs most of the mechanical and thermal properties and the strong resistance to corrosive agents. They also serve to obtain strong bonds between the two phases (β-SiC matrix and inclusions) avoiding problems of rejection or detachment during use under stress. Moreover, if α-SiC inclusions are used, this material has a thermal expansion coefficient very close to that of the β-SiC matrix, thereby avoiding the formation of residual stresses liable to appear in the composite during the heat treatment or during the cooling; this avoids the formation of cracks which could be detrimental to the finished part during its use;

(iv) due to the absence of binders having lower resistance to said corrosive media, the material or composite of the invention has extremely high resistance to corrosive media, particularly fluorinated media, concentrated acids and alkaline media. The parts produced from this novel material or composite according to the invention thereby allow a better economy of use. More particularly, in a given aggressive medium, the lifetime of the parts of the invention is longer than that of known SiC-based parts. This also improves the safety of use of the SiC parts, particularly their fluid-tightness, and opens up other applications that would be inconceivable with the SiC-based materials according to the prior art, wherein the binders are not chemically inert;

(v) by varying the chemical and physical nature of the inclusions, the inventive method also serves to prepare other types of composite not only containing silicon carbide but also other materials such as alumina, silica, or any other compounds, provided that they can be dispersed in the resin and are not altered during the synthesis. The addition of these inclusions other than α-SiC, in variable proportions, serves to modify at will the mechanical and thermal properties of the final composite, i.e. improved heat transfer, oxidation resistance or pore clogging; and

(vi) by varying the proportion of the inclusions, and particularly the mass percentage of α-SiC, the thermal and mechanical strength of the material can be varied according to the intended application.

The inventive method is suitable for producing β-SiC-based products or parts which substantially have the same properties of use as those prepared under vacuum or under inert gas. This is true in particular of the resistance to fluorinated or chlorinated media at high temperature, which may be decisive when said products are used for lining electrolysis cells for producing aluminum from a molten alumina-cryolite mixture, or for lining incinerators. In fact, this ceramic has numerous applications. It can be used, in particular in the form of refractory plates or bricks, as a lining material in various locations related to thermal engineering, chemical engineering and/or electrometallurgical engineering subject to high mechanical and thermal stresses, and/or in the presence of corrosive liquids or gases. It may particularly be used in components of heat exchangers, burners, furnaces, reactors, or heating resistors, particularly in oxidized media at medium or high temperature, or in installations in contact with corrosive chemicals. The inventive material can be used as an internal lining of furnaces, such as aluminum smelters, and for lining molten salt electrolysis cells, for example for producing aluminum by electrolysis from a mixture of alumina and cryolite.

The inventive method is also suitable for producing complex fabricated parts, particularly by molding, and tubes, particularly by extrusion, and also granules.

The examples below illustrate various embodiments of the invention and demonstrate its advantages; they do not limit the present invention.

### EXAMPLES

### Example No. 1

A homogeneous paste is prepared by blending 49% fine silicon metal powder, 18% carbon black and 33% phenolic resin. This paste is formed into 3 mm diameter granules by extrusion, then heated in air for 3 h at 200° C. to set the resin.

Precursor granules are thereby obtained, which can be converted to SiC by heating under appropriate conditions.

### Example No. 2

15 cm³ (16.3 g) of precursor extrudates prepared according to example No. 1 are placed in a 23 cm³ alumina cartridge. 16 g of α-SiC powder having a particle size smaller than 200 μm are added and the combination is then vibrated to make the powder fill the space left free between the extrudates. The cartridge is then closed by a ceramic felt tamped to a thickness of 1 cm. The cartridge is then heated for 1 hour at 1400° C. in a tube furnace through which a continuous stream of argon is passed. After treatment, the cartridge is emptied and the extrudates are separated from the α-SiC powder by screening. The x-ray diffraction analysis shows that the precursor granules have been converted to β-SiC.

These β-SiC granules are immersed in a 40 vol % HF solution for 24 hours, then rinsed with water and dried. The treatment of the granules with HF causes a weight loss of about 6% without any effect on the morphology of the particles.

### Example No. 3

The test in example No. 2 is repeated with the exception of the heating of the cartridge for 1 hour at 1400° C., which is carried out in a furnace containing air instead of argon. After unloading and screening the extrudates, they are immersed in the 40 vol % HF solution for 24 hours, then rinsed with water and dried. The treatment of the granules with HF causes a weight loss of about 5% without any effect on the morphology of the particles.

### Comparative Example No. 1

15 cm³ of precursor extrudates prepared according to example No. 1 are placed in a furnace then treated for 1 hour at 1400° C. in air. After treatment in the furnace, the granules are immersed in the 40 vol % HF solution for 24 hours. This treatment with HF causes a drastic change in the morphology of the granules, which are nearly completely dissolved in the HF solution, an unquantifiable solid residue being observed in powder form at the bottom of the HF tank.

### Example No. 4

A binder is prepared by blending 55% phenolic resin and 45% fine silicon metal powder.

This binder is then used in a blend with α-SiC particles in respective proportions of 12% and 88%. The blend thus obtained is then pressed to form a brick which is hardened by heating for 3 hours at 150° C. in air. At this stage, the brick consists of α-SiC particles embedded in a precursor matrix which can be converted to β-SiC by heating under appropriate conditions.

### Example No. 5

A brick prepared according to example No. 4 is treated for 1 hour at 1360° C. in a furnace inerted by continuous argon flushing. At the furnace outlet, the brick has good mechanical strength, which is preserved after a residence of 24 hours in a 40 vol % hydrofluoric acid bath. The weight loss during this treatment with HF is less than 1%. Apart from the α-SiC introduced initially, the x-ray diffraction analysis also shows the presence of β-SiC which is formed from the binder and serves to maintain the cohesion between the α-SiC particles.

### Example No. 6

A brick prepared according to example No. 4 is placed in a ceramic box covered with a lid and adjusted to the size of the part. The whole is then treated for 5 hours at 1380° C. in a furnace flushed with an oxidizing atmosphere. At the furnace outlet, the brick has good mechanical strength which is preserved after a residence of 24 hours in a 40 vol % hydrofluoric acid bath. The weight loss during this treatment with HF is about 1.5%.

### Comparative Example No. 2

A brick prepared according to example No. 4 is treated directly for 5 h at 1380° C. in a furnace flushed with an oxidizing atmosphere, without confinement in a ceramic box. At the furnace outlet, the brick has good mechanical strength but is reduced completely to particles after residing for only 2 hours in a 40 vol % hydrofluoric acid bath. Contrary to examples 5 and 6, the cohesion between the α-SiC particles is no longer ensured after treatment in HF medium because the β-SiC precursor has not been properly converted to β-SiC binder during the curing at high temperature.

1. A method for producing a composite based on β-SiC comprising:
(a) preparing a precursor blend comprising at least one β-SiC precursor and at least one carbon-containing resin, and optionally thermosetting,
(b) forming a precursor mixture, optionally into granules, plates, tubes or bricks, to form an intermediate part;
(c) curing the resin;
(d) introducing said intermediate part into a receptacle;
(e) closing said receptacle with a closure means allowing gas overpressure to escape;
(f) heat treating said intermediate part at a temperature of from 1100 to 1500° C. to remove an organic component of the resin and form β-SiC in a final part.

2. The method as claimed in claim 1, wherein (a) comprises (aa):
(aa) preparing a precursor blend comprising inclusions, at least one part of which consists of α-SiC, at least one β-SiC precursor and at least one carbon-containing resin.

3. The method as claimed in claim 1, wherein the heat treatment step is carried out at a temperature from 1200° C. to 1500° C.

4. The method as claimed in claim 1, wherein the β-SiC precursor is silicon, optionally in the form of a powder having an average diameter of from 0.1 μm to 20 μm.

5. The method as claimed in claim 1, wherein the thermosetting resin is selected from the group consisting of phenolic, acrylic and furfurylic resins.

6. The method as claimed in claim 1, wherein the resin curing temperature step is from 150 to 300° C.

7. The method as claimed in claim 2, wherein said inclusions and/or precursors are in the form of powder, particles or fibers.

8. The method as claimed in claim 2, wherein the weight fraction of said inclusions is from 80 to 95% of the total weight of the precursor blend.

9. The method as claimed in claim 2, wherein at least a part of said inclusions comprise alumina, silica, TiN, and/or Si₃N₄.

10. The method as claimed in claim 9, wherein at least 50% by weight of said inclusions are α-SiC.

11. The method as claimed in claim 1, wherein the volume of the receptacle that is unoccupied by said intermediate part is filled with an inert solid, optionally a solid that is separable and recoverable, so that the volume occupied by the gas in the receptacle is not more than 50% greater than the volume external of the intermediate part.

12. The method as claimed in claim 11, wherein the volume occupied by the gas in the receptacle is not more than 20% greater than the volume external of the intermediate part.

13. The method as claimed in claim 1, wherein the gas overpressure is generated by the parts to be treated at a temperature between the ambient temperature and 800° C., and the volume of gas overpressure is at least equal to twice, the volume occupied by the gas in the receptacle.

14. A product obtainable by the method as claimed in claim 1.

15. A product produced by the production method as claimed in claim 1, said product being in the form of plates or bricks suitable as an internal lining of a molten salt electrolysis cell and/or as an internal lining of an incinerator.

16. An electrolysis cell for producing aluminum from a mixture of alumina and cryolite comprising a product of claim 15.

17. A product obtainable by the method as claimed in claim 2.

18. A product obtainable by the method as claimed in claim 3.

19. A product produced by the production method as claimed in claim 2, said product being in the form of plates or bricks suitable as an internal lining of a molten salt electrolysis cell and/or as an internal lining of an incinerator.

20. An electrolysis cell for producing aluminum from a mixture of alumina and cryolite comprising a product of claim 19.
